(19) United States
(12) Patent Application Publication
(10) Pub. No.: US 2008/0320279 A1
(43) Pub. Date: Dec. 25, 2008

(54) MANAGEMENT OF A COMMUNICATION LINK EXTENDED TO ONE OR MORE SLAVE DEVICES

(75) Inventor: David Machin, Harpenden (GB)

Correspondence Address: FITZPATRICK CELLA HARPER & SCINTO, 30 ROCKEFELLER PLAZA, NEW YORK, NY, 10112, US

(73) Assignee: Cambridge Silicon Radio Limited, Cambridge (GB)

(21) Appl. No.: 12/142,063

(22) Filed: Jun. 19, 2008

(30) Foreign Application Priority Data
Jun. 22, 2007 (GB) 0712273.2

(51) Int. Cl. G06F 15/76; G06F 9/02

(52) U.S. Cl. 712/29; 712/E09.002

(57) ABSTRACT

A master device for managing a communications link to slave devices (for example in the context of a Wireless USB cluster), wherein the master device is configured to facilitate avoidance of unnecessary waking of the slave devices.

### TECHNICAL FIELD

The invention relates to communications links between master and slave devices, in which the slave devices must periodically achieve readiness to receive information from the link.

### BACKGROUND

The “Wireless Universal Serial Bus Specification” (revision 1.0) from the USB Implementers Forum lays out a scheme by which a host, such as a desktop PC, can communicate wirelessly with remote devices, such as media players and keyboards. In general terms, this scheme provides that a host will set up a Wireless USB channel to which remote devices can attach. A host imbues its Wireless USB channel with a “stream index” which serves as an identifier for the channel. A host will repeatedly place a “host identifier information element” on its Wireless USB channel, the host identifier IE (information element) containing, amongst other things, the stream index. Remote devices use the host identifier IE (and the embedded stream index) in the process of attaching to a Wireless USB channel. The remote devices attached to a Wireless USB channel form, together with the host that provides the Wireless USB channel, a Wireless USB Cluster.

In a Wireless USB channel, time is measured out in terms of super-frames and each super-frame is divided up into 256 Media Access Slots (MASs). A Beacon Period is provided at the start of each super-frame. A Wireless USB channel contains a continuous sequence—or thread—of linked application-specific control packets known as Micro-scheduled Management Commands (MMCs). Each MMC contains a header including, amongst other things, the Wireless USB channel's stream index and an indication of the time at which the next MMC in the thread will occur. A host can insert into an MMC instructions (that is, IEs) for particular remote devices to engage in data transfer with the host device. The transfer is to take place in a transaction group following the MMC.

A remote device attached to Wireless USB channel needs to receive the MMCs to determine whether it needs to engage in data transfer with the host. It may be the case that a remote device need not conduct such transfer, in which case it can enter an idle mode—potentially with reduced power consumption—until the next MMC arrives. Since the host provides a thread of MMCs which remote devices attached to the Wireless USB channel must track, it is reasonable to refer to the host as a master device and to the remote devices as slave devices and that nomenclature will be used for the remainder of this document.

Further information about the conduct of Wireless USB communications can be obtained from the aforementioned USB-IF specification.

### BRIEF SUMMARY

According to one aspect, the present invention provides a master device for managing a communications link to one or more slave devices, wherein the master device is arranged to endow the link with a thread of time points at which slave devices following the thread must ordinarily comply with a requirement of being ready to receive information from the link and the master device is arranged to provide an indication to a slave device capable of causing that slave device to not comply with said requirement at one or more of said points. The invention also consists in a method of managing a communications link from a master device to one or more slave devices, the method comprising endowing the link with a thread of time points at which slave devices following the thread must ordinarily comply with a requirement of being ready to receive information from the link and providing an indication to a slave device capable of causing that slave device to not comply with said requirement at one or more of said points.

In certain embodiments, the indication may, for example, be interpreted by the recipient slave device as a command to be obeyed, whereas, in other embodiments, the indication may, for example, be interpreted by the recipient slave device as a suggestion or invitation.

According to another aspect, the invention provides a master device for managing a communications link to one or more slave devices, wherein the master device is arranged to endow the link with a first thread of time points at which slave devices following the first thread must comply with a requirement of readiness to receive information from the link and the master device is arranged to endow the link with a second thread of time points at which slave devices following the second thread must comply with said requirement, wherein an interval separating a pair of adjacent points in said first thread differs from an interval separating a pair of adjacent points in said second thread. The invention also consists in a method of managing a communications link to one or more slave devices, the method comprising endowing the link with a first thread of time points at which slave devices following the first thread must comply with a requirement of readiness to receive information from the link and endowing the link with a second thread of time points at which slave devices following the second thread must comply with said requirement, wherein an interval separating a pair of adjacent points in said first thread differs from an interval separating a pair of adjacent points in said second thread.

According to a further aspect, the invention provides apparatus comprising a hardware portion and a software element, wherein the software element interacts with the hardware portion to produce several different master devices, wherein the master devices are arranged to manage respective communications links to respective slave devices and to endow their respective links with respective threads of time points at which attached slave devices must comply with a requirement of readiness to receive information from the respective links and wherein the apparatus is arranged to run the threads at least partly in parallel.

Therefore, the invention provides the ability to exert independent control over the number and frequency of occasions on which different slave devices need to achieve readiness to receive information from the link. It can be advantageous to control this facet of a system since achieving this readiness usually consumes processing resource and electrical power and it is almost always desirable to minimise such consumption, e.g. to conserve battery life.

In embodiments where the master device is arranged to indicate to a slave device that the slave device need not comply with the readiness requirement at one or more points, the master device may for example instruct that slave device to skip compliance with the readiness requirement for a certain number of the following time points in the thread.

According to the aforementioned USB-IF document, a Wireless USB cluster comprises a host controlling data transfer with remote devices over a Wireless USB channel containing a thread of MMCs. In certain embodiments, the (or each) master device is the host device of a Wireless USB cluster, the (or each) slave device is a remote device of a Wireless USB cluster, the (or each) link is a Wireless USB channel and the (or each) thread of time points is an MMC thread in a Wireless USB channel.

### BRIEF DESCRIPTION OF THE DRAWINGS

By way of example only, certain embodiments of the invention will now be described with reference to the accompanying drawings, in which:

FIG. 1 is a block diagram of a Wireless USB cluster;

FIG. 2 is a schematic diagram of a MMC thread in a Wireless USB channel;

FIG. 3 is a schematic diagram of a pair of MMC threads in a Wireless USB channel;

FIG. 4 is a schematic diagram of a pair of MMC threads in respective Wireless USB channels;

FIG. 5 is a block diagram of a master device suitable for producing the Wireless USB channels of FIG. 4 and

FIG. 6 is a block diagram providing a high-level, schematic illustration of a Wireless USB enabled device.

### DETAILED DESCRIPTION

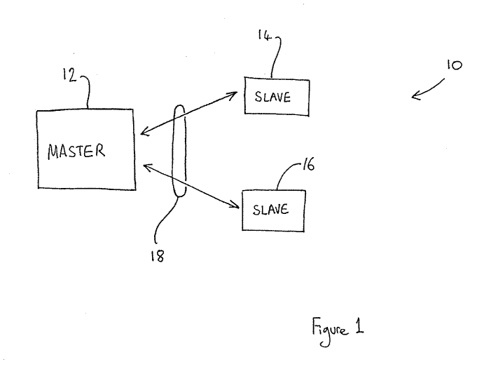

FIG. 1 shows a Wireless USB cluster 10 comprising a master device 12 and two slave devices 14 and 16. In this example, the master device 10 is a PC, slave device 14 is a media player and slave device 16 is a keyboard. The master device 12 maintains a Wireless USB channel 18 through which it communicates with the slave devices 14 and 16 in accordance with the details set out in the aforementioned “Wireless Universal Serial Bus Specification”.

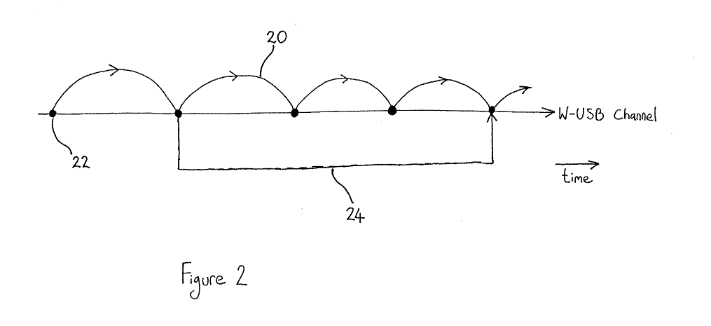

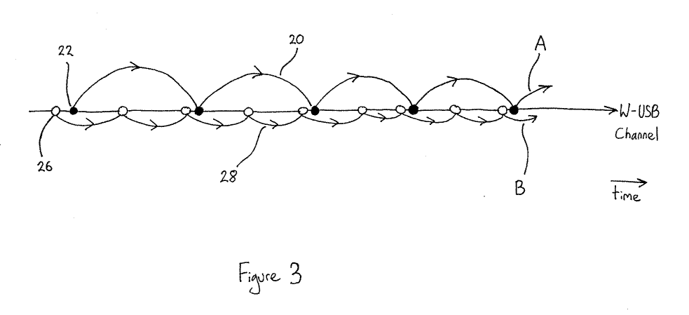

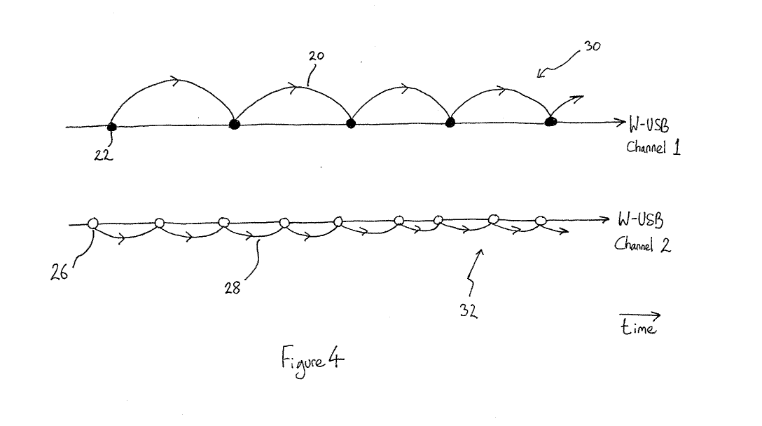

The Wireless USB channel 18 is depicted in FIG. 2. The thread of MMCs laid down in the Wireless USB channel 18 by the master device is shown as a series of hops, e.g. 20, and the MMCs are signified by black dots, e.g. 22. Time flows from left to right in FIG. 2 (and in FIGS. 3 and 4).

Amongst other things, each MMC contains, as mentioned earlier, a pointer to the time of the next MMC in the thread and instructions to specific slave devices to engage in data transfer with the host device. The slave devices 14 and 16 are configured to conserve power and processing resources in a known manner by deactivating parts of their receiver functionality when they are not required to engage in data transfer over the Wireless USB channel 18. In summary, this is achieved in the following manner. Upon receiving an MMC, a slave device notes the time of the next MMC in the thread and determines whether the current MMC contains any instructions for the slave device in question to engage in data transfer with the master device 12 in the period following the current MMC. If there are no such instructions, then the slave device performs the aforementioned deactivation and restores the receiver functionality just in time to receive the next MMC.

It will be apparent that slave device 14 (handling items such as music files and video clips) will almost certainly require a higher data transfer rate through the Wireless USB channel 18 than is required by slave device 16 (which simply relays keystrokes). Therefore, at any given MMC, the slave device 16 is less likely than slave device 14 to be required to participate in data transfer through the Wireless USB channel 18. As a result, there is, at any given MMC, a higher probability for slave device 16 than for slave device 14 that the receiver functionality is being reactivated needlessly, and needless reactivation amounts to wastage of electrical power and processing resources.

To avoid this problem, the master device 12 can insert an additional IE into an MMC. The additional IE shall be referred to in this document as a skip instruction. The skip instruction is addressed to a particular slave device and specifies that the indication, in the MMC that conveys the skip instruction, of the next MMC in the thread can be ignored and that the next MMC of interest to that slave device will occur in x microseconds. The value x is chosen by the master device such that the addressed slave device will skip over at least one MMC in the thread, thus avoiding needless reactivation of the receiver side of that slave device.

Accordingly, the master device 12 inserts into an MMC in the Wireless USB channel 18 a skip instruction addressed to slave device 16. On this particular occasion, x is such that the receiver side of slave device 16 remains dormant for the next two MMCs of the thread, as indicated by arrow 24 in FIG. 2. Because the skip instruction is addressed to slave device 16, it is ignored by slave device 14, which simply continues to follow the MMC thread. As a result of the use of the skip instruction, consumption of processing resources and electrical power by slave device 16 can be reduced.

FIG. 3 outlines a further scheme for conserving energy and processing resources within slave devices 14 and 16. According to this arrangement, the master device 12 sets up two threads of MMCs in the Wireless USB channel 18. As in FIG. 2, one of these threads, “thread A”, is signified by black dots, e.g. 22, representing MMCs, with the MMCs being interconnected by hops, e.g. 20. In the other thread, “thread B”, the MMCs are represented by white dots, e.g. 26, interconnected by hops such as 28. It will be apparent that the MMCs of thread A are much less closely spaced than the MMCs of thread B. This means that a slave device, upon deactivating its receiver functionality due to an absence of a need to participate in data exchange as deduced from an MMC, will remain in the deactivated state longer if it is following thread A than if it is following thread B.

The MMCs defining thread A are given a different stream index to the MMCs defining thread B. Accordingly, the master device 12 can insert into the MMCs an instruction for a given slave device to use the one of the two stream index values corresponding to the thread that is best suited to the slave device's likely data transfer rate requirements. Thus, slave devices can be directed to follow whichever of the two threads is most appropriate. Accordingly, slave device 16 is instructed to follow thread A and slave device 14, with its greater data transfer needs, is instructed to follow thread B. Since the receiver functionality of slave device 16 is then reactivated less frequently (than if it were attached to thread B), needless receiver functionality reactivation of slave device 16, with the associated consumption penalties, is less likely to occur.

FIG. 4 sets out another scheme for conserving energy and processing resources within slave devices 14 and 16. According to this arrangement, the master device 12 sets up two distinct Wireless USB channels 30 and 32, each containing its own thread of MMCs and each using its own stream index value. The MMCs in Wireless USB channel 30 are indicated by black dots, e.g. 22, interconnected by hops such as 20 and the MMCs in Wireless USB channel 32 are indicated by white dots, e.g. 26, interconnected by hops such as 28. It will be apparent that the MMCs of the thread in Wireless USB channel 30 are much less closely spaced than the MMCs of the thread in Wireless USB channel 32. This means that a slave device, upon deactivating its receiver functionality due to an absence of a need to participate in data exchange as deduced from an MMC, will remain in the deactivated state longer if it is following the thread in Wireless USB channel 30 than if it is following the thread in Wireless USB channel 32. Accordingly, the master device 12 can instruct the slave devices to join the most appropriate Wireless USB channel, depending on their likely data transfer rate requirements. Here, slave device 16 is instructed to join Wireless USB channel 30 and slave device 14, with its greater data transfer needs, is instructed to join Wireless USB channel 32. Since the receiver functionality of slave device 16 is then reactivated less frequently (than if it were attached to the thread in Wireless USB channel 32), needless receiver functionality reactivation of slave device 16, with the associated consumption penalties, is less likely to occur.

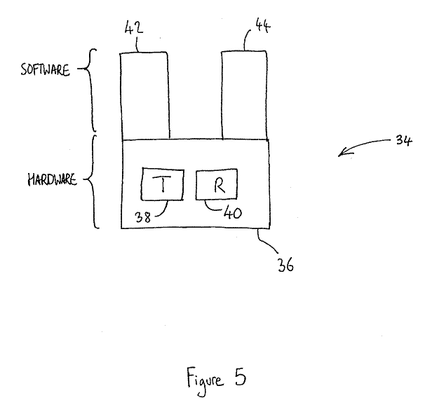

A conventional master device for a Wireless USB cluster comprises a hardware section, e.g. including transmit and receive circuitry, controlled by a software section. FIG. 5 shows an adaptation of such a structure that is suitable for producing the Wireless USB channel pair that is shown in FIG. 4. FIG. 5 shows a master device 34 for administering a Wireless USB cluster, comprising a hardware section 36 including, amongst other similarly conventional elements, transmitter circuitry 38 for transmitting information to slave devices and receiver circuitry 40 for receiving information from slave devices. The software section that controls the hardware section 36 is, however, unconventional in that certain elements of the conventional software section are duplicated so as to provide two separate software controllers 42 and 44 for the hardware section. These software controllers time-share the control of the hardware section 36 and each controller 42, 44 combines with the hardware section to produce a master device for administering a Wireless USB cluster. Effectively then, the two software controllers 42 and 44 utilise the hardware section for administering separate Wireless USB clusters, each cluster having its own Wireless USB channel with its own MMC thread. The MMC threads established by the different controllers can then be provided with different hop sizes as in FIG. 4 and a slave device can be instructed to join the one of the Wireless USB clusters that has the MMC thread hop size that is most appropriate to the slave device's likely data transfer requirements thereby avoiding unnecessary recovery from receiver functionality deactivation.

Various embodiments have been described in which control is exerted over the interval between a slave device actively receiving one MMC and then another. A slave device can be adapted to influence the way in which this “dormancy interval” is manipulated and two examples of how this might be achieved will now be described.

As a first example, a slave device could request its master device to adopt a particular value for the maximum length of the dormancy interval (at least insofar as this particular slave device is concerned), perhaps to avoid compromising operation of a data source or data sink in the slave device. The request could be provided when the slave device joins a Wireless USB cluster, for example by including the suggested maximum length in a “Device Descriptor”, an “Endpoint Descriptor” or an “Endpoint Companion Descriptor” (which terms are defined in the USB-IF document mentioned earlier). The request could be provided dynamically while a slave device is connected into a Wireless USB cluster by transmitting the suggested maximum length as part of a “Device Notification” (again, a term defined in the USB-IF document mentioned earlier).

As a second example, a slave device could influence the dormancy interval by requesting (in, for example, a Device Notification) that the master device refrain from engaging the slave device in data transfer during a specified time period. A slave device may desire to send such a request when, for example, the slave device is, or is going to be, temporarily unable to accept or furnish data (consider, for example, a slave device with full data buffers flushing to a Flash device or waiting for a hard drive to seek).

The effect of a suggested maximum dormancy interval will vary from embodiment to embodiment. In the FIG. 2 scheme, a suggested maximum dormancy interval from a slave device may, for example, cause the master device to constrain the maximum value of the parameter x (or, in other words, to impose an upper limit on the number of MMCs that can be bypassed using the skip instruction) when dealing with that slave device. In the schemes of FIGS. 3 and 4, a suggested maximum dormancy interval from a slave device may, for example, prompt the master device to avoid attaching the slave device to an MMC thread with too high a dormancy interval or to shift the slave device to an MMC thread with a lower dormancy interval.

The effect of a slave device signalling to its master device a period of temporary inability to engage in data transfer will also vary from embodiment to embodiment. In the FIG. 2 scheme, the master device might, for example, respond by temporarily increasing the value used for parameter x in its dealings with this slave device. In the FIGS. 3 and 4 schemes, the master device might, for example, respond by temporarily shifting the slave device from its current MMC thread to an MMC thread with a higher dormancy interval.

Some of the described embodiments employ two MMC threads or even two Wireless USB channels. It will of course be understood by the skilled person that the choice of two threads/channels is in a sense arbitrary and that greater numbers of threads/channels could indeed be used. It will also be apparent to the skilled person that the concepts explained by reference to FIGS. 2, 3 and 4 can be combined together as desired to provide even greater flexibility in controlling receiver functionality reactivation in slave devices. For example, one of the software controllers of FIG. 4, say 42, could be adapted so that it manifests itself as a Wireless USB master device having two MMC threads as in FIG. 3 or perhaps as capable of issuing the “skip instruction” of FIG. 2.

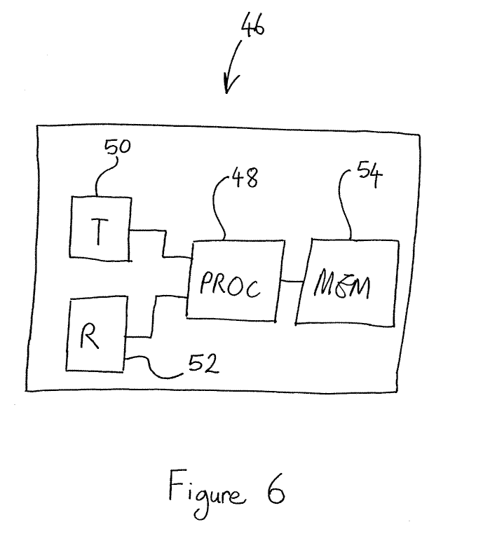

FIG. 6 shows a conventional hardware structure 46 for a Wireless USB device that could represent the hardware structure of any master or slave device in an embodiment of the present invention. The structure 46 is illustrated at a very high level and shows a processor 48 that operates, amongst other things, an RF transmitter 50 and an RF receiver 52. The processor 48 is controlled by program code stored in a memory 54. This code is not conventional and it causes the conventional structure 46 to perform techniques embodying the invention, for example as described above with reference to FIGS. 2 to 4. When the structure 46 forms part of a device that is playing the role of a master device of a Wireless USB cluster, then the processor is programmed with code from the memory 54 that directs the processor to manage the cluster, via the transmitter 50 and the receiver 52, in a manner in accordance with the present invention, for example as set out in one of FIGS. 2 to 4. On the other hand, when the structure 46 forms part of a device that is playing the role of a slave device of a Wireless USB cluster, then the processor is programmed with code from the memory 54 that directs the processor to participate in the cluster, via the transmitter 50 and the receiver 52, in a manner in accordance with the present invention, for example as set out in one of FIGS. 2 to 4.

It will be apparent that the structure 46 is merely exemplary and that many possible variations exist. For example, the transmitter 50 and the receiver 52 could be integrated into a transceiver element and/or the memory 54—or at least part of it—could be integrated with the processor 48 to form a single element. By way of a further example, the structure 46 could be modified to include an application specific integrated circuit (ASIC) to control the transmitter 50 and the receiver 52 in place of the processor 48 operating under the control of code from the memory 54. It will be apparent to the skilled person that the specific hardware structure that is used to implement the Wireless USB cluster management techniques according to the invention is in fact relatively unimportant.

1. A master device for managing a communications link to one or more slave devices, the master device comprising a processor and a memory for storing instructions to be carried out by the processor and wherein the processor is arranged to endow the link with a thread of time points at which slave devices following the thread must ordinarily comply with a requirement of being ready to receive information from the link and the processor is arranged to provide an indication to a slave device capable of causing that slave device to not comply with said requirement at one or more of said points.

2. A master device according to claim 1, wherein the processor is arranged to provide said indication by indicating to the slave device the next of said points at which it need comply with said requirement, wherein that point is not the next of said points to occur in the thread.

3. A master device according to claim 1, wherein the processor is arranged to determine whether to issue said indication based at least in part on at least one of a data transfer requirement of, and a power requirement of, the slave device.

4. A master device for managing a communications link to one or more slave devices, the master device comprising a processor and a memory for storing instructions to be carried out by the processor and wherein the processor is arranged to endow the link with a first thread of time points at which slave devices following the first thread must comply with a requirement of readiness to receive information from the link and the processor is arranged to endow the link with a second thread of time points at which slave devices following the second thread must comply with said requirement, wherein an interval separating a pair of adjacent points in said first thread differs from an interval separating a pair of adjacent points in said second thread.

5. A master device according to claim 4, wherein none of said first thread points coincides with any of the second thread points.

6. A master device according to claim 4, wherein the processor is arranged to direct a slave device to follow a particular one of the thread based at least in part on at least one of a data transfer requirement of, and a power requirement of, the slave device.

7. Apparatus comprising a hardware portion and a software element, wherein the software element interacts with the hardware portion to produce several different master devices, wherein the master devices are arranged to manage respective communications links to respective slave devices and to endow their respective links with respective threads of time points at which attached slave devices must comply with a requirement of readiness to receive information from the respective links and wherein the apparatus is arranged to run the threads at least partly in parallel.

8. Apparatus according to claim 7, wherein an interval separating a pair of adjacent points in one of said threads differs from an interval separating a pair of adjacent points in the other of said threads.

9. Apparatus according to claim 7, wherein none of said first thread points coincide with any of the second thread points.

10. Apparatus according to claim 7, wherein the master device is arranged to direct a slave device to use a particular one of the threads based at least in part on at least one of a data transfer requirement of, and a power requirement of, the slave device.

11. A slave device for participating in a communications link managed by a master device and containing time points, specified by the master device, at which the slave device must comply with a requirement of being ready to receive information from the link, wherein the slave device comprises means for receiving information from the link and means for providing information to the master device for influencing the separation of the time points.

12. A slave device according to claim 11, wherein said information comprises a desired maximum duration for said separation.

13. A slave device according to claim 11, wherein said information comprises an indication of an interval in which the slave device shall not utilise the link.

14. A method of managing a communications link from a master device to one or more slave devices, the method comprising endowing the link with a thread of time points at which slave devices following the thread must ordinarily comply with a requirement of being ready to receive information from the link and providing an indication to a slave device capable of causing that slave device not comply with said requirement at one or more of said points.

15. A method according to claim 14, wherein providing said indication comprises indicating to the slave device the next of said points at which it need comply with said requirement, wherein that point is not the next of said points to occur in the thread.

16. A method according to claim 14, further comprising determining whether to issue said indication based at least in part on at least one of a data transfer requirement of, and a power requirement of, the slave device.

17. A method of managing a communications link from a master device to one or more slave devices, the method comprising endowing the link with a first thread of time points at which slave devices following the first thread must comply with a requirement of readiness to receive information from the link and endowing the link with a second thread of time points at which slave devices following the second thread must comply with said requirement, wherein an interval separating a pair of adjacent points in said first thread differs from an interval separating a pair of adjacent points in said second thread.

18. A method according to claim 17, wherein none of said first thread points coincide with any of the second thread points.

19. A method according to claim 17, further comprising directing a slave device to use a particular one of the threads based at least in part on at least one of a data transfer requirement of, and a power requirement of, the slave device
